(19) United States
(12) Patent Application Publication
(10) Pub. No.: US 2023/0306097 A1
(43) Pub. Date: Sep. 28, 2023

(54) Confirm Gesture Identity

(71) Applicant: Apple Inc., Cupertino, CA (US)

(72) Inventors: Nathaniel R. Finney, San Francisco, CA (US); Jean-Charles Bernard Marcel Bazin, Sunnyvale, CA (US); Srimanth Gunturi, San Ramon, CA (US)

(21) Appl. No.: 18/189,570

(22) Filed: Mar. 24, 2023

Related U.S. Application Data
(63) Continuation of application No. PCT/US2021/052038, filed on Sep. 24, 2021.
(60) Provisional application No. 63/083,353, filed on Sep. 25, 2020.

(51) Int. Cl. G06F 21/32; G06V 40/10; G06F 3/01

(52) U.S. Cl. CPC G06F 21/32; G06V 40/117; G06F 3/017

(57) ABSTRACT

Techniques for authenticating a user based on hand features includes receiving sensor data of a scene that includes hands, extracting features for at least one of the hands, and determining a first identity associated with the at least one hand based on the extracted features. The user identity may be associated with authentication information such that when a system detects a gesture by the hands, the authentication information is assessed prior to performing an action associated with the gesture. Authenticated users may be used for determining authorized activity for performing an action associated with a gesture, and may be used for collaborative activity among users.

### BACKGROUND

Some devices are capable of generating and presenting extended reality (XR) environments. An XR environment may include a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with realistic properties. Some XR environments allow multiple users to interact with virtual objects or with each other within the XR environment. For example, users may use gestures to interact with components of the XR environment. However, what is needed is an improved technique to manage determining identity of a user performing a gesture.

### BRIEF DESCRIPTION OF THE DRAWINGS

FIG. 1 shows a system setup for managing identities of users active in a scene, in accordance with some embodiments.

FIG. 2 shows a flowchart of a technique for registering hands of a user in accordance with some embodiments.

FIG. 3 shows a flowchart of a technique for identifying users in a scene based on hand features, in accordance with some embodiments.

FIG. 4 shows a flowchart of a technique for managing identities of users active in a scene, in accordance with some embodiments.

FIG. 5 shows a system setup for determining authorization of a user based on hand features, in accordance with some embodiments.

FIG. 6 shows a flowchart of a technique for determining authorization of a user based on hand features, in accordance with some embodiments.

FIG. 7 shows an example diagram of a technique for identifying user hands, in accordance with some embodiments.

FIG. 8 shows a flow diagram of a technique for extracting hand features from image data, in accordance with some embodiments.

FIG. 9 shows a flowchart of a technique for selecting hands to track in a scene, in accordance with some embodiments.

FIG. 10 shows, in block diagram form, exemplary systems for confirming gesture identity, according to some embodiments.

FIG. 11 shows an exemplary system for use in various extended reality technologies.

### DETAILED DESCRIPTION

This disclosure pertains to systems, methods, and computer readable media to determine user identity based on features of the user's hands. In some embodiments, sensor data for one or more hands may be received. Hand features may be extracted for the hands. A user identity may be determined based on the extracted features. In some embodiments, the user identity may be used to determine authorization of a user to cause certain actions to be performed when providing a gesture. The gesture may be recognized in a scene, and an identity of the gesture may be determined. Based on the identity, a system may determine whether an action associated with the gesture is authorized for the identity of the user performing the gesture.

According to some embodiments, sensor data capturing a surrounding environment may be used to extract hand features. In some embodiments, a 2D image frame may be used to extract hand features, which may be used for hand tracking. According to one or more embodiments, a network may be trained to read in sensor data, such as a 2D image frame, and generate hand features, such as a bounding box, hand keypoints, a hand center, and chirality of the hand. The network may be trained to provide 3D data for the hand features based on a single 2D image frame. For example, the keypoints, bounding box, and/or hand center may be provided in the form of 3D coordinates in space.

In some embodiments, the hand features may be utilized to predict whether a particular hand in the environment belongs to a particular user who should be tracked. For example, a user of a device capturing the sensor data may be tracked, whereas other hands in the scene should be ignored. The hand features for the hands to be tracked may then be utilized for hand tracking techniques.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

For purposes of this disclosure, a multi-user communication session can include an XR environment in which two or more devices are participating.

For purposes of this disclosure, a local multi-user communication device refers to a current device being described, or being controlled by a user being described, in a multi-user communication session.

For purposes of this disclosure, colocated multi-user communication devices refer to two or more devices that share a physical environment and an XR environment, such that the users of the colocated devices may experience the same physical objects and virtual objects.

For purposes of this disclosure, shared virtual elements refer to virtual objects that are visible or otherwise able to be experienced by participants in a common XR session.

For purposes of this disclosure, a remote user refers to a user of a different electronic device than the local device who may be in a same local physical environment or a different physical environment.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of graphics modeling systems having the benefit of this disclosure.

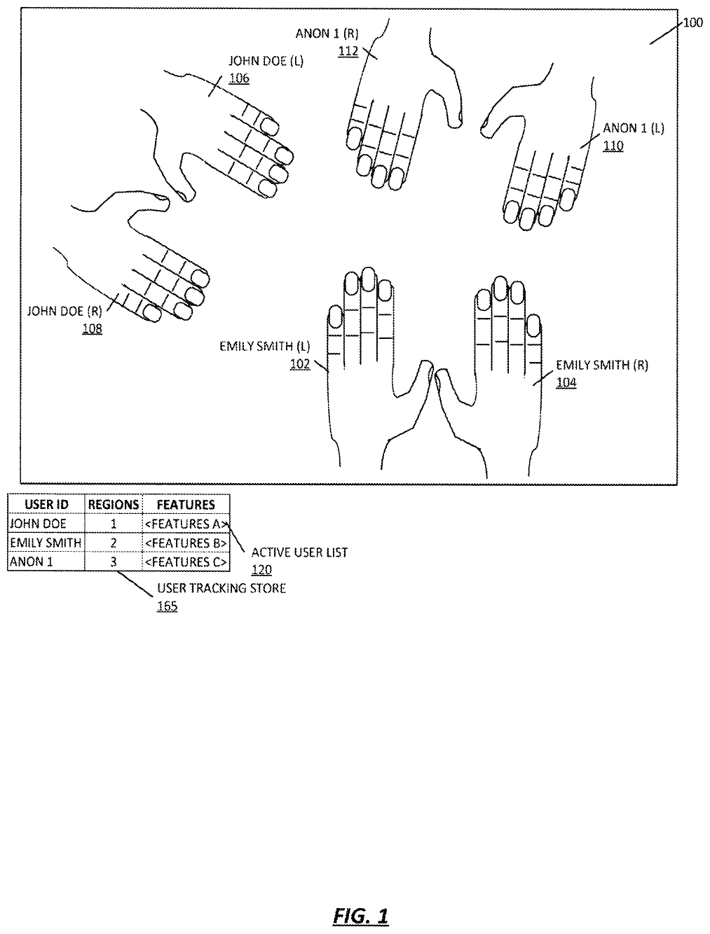

FIG. 1 shows a system setup for managing identities of users active in the scene, in accordance with some embodiments. The system setup 100 includes a view of three sets of hands. Initially, hands in the scene may be detected. Hands may be detected, for example, based on sensor data capturing the view, or portion of the environment within the capture area of the sensors. As shown, six hands may be detected in the view. Further, the hands in the view may be identified and assigned an identifier based on the identification. The identifier may be assigned to each hand or pair of hands, in some embodiments. The hands detected in the view include Emily Smith's left hand 102, Emily Smith's right hand 104, John Doe's left hand 106, John Doe's right hand 108, and two unknown hands including an anonymous left hand 110 and an anonymous right hand 112. In some embodiments, an anonymous, or unknown, user may be assigned an anonymous user profile for identification and tracking purposes. The anonymous profile may be associated with features for the particular hand so that the unknown hand can be identified and tracked, for example. The identified hands may be recorded in an active user list 120 to identify users active in a scene. The active user list 120 depicts the user identity for the two known users Emily Smith and John Doe, as well as an unknown user as an anonymous user profile for Anon 1. For each user, one or more regions is tracked, as well as features for the hands belonging to that user. In some embodiments, the features may also include additional features, for example from a network feature store or other source comprising preregistered features for one or more users. For example, the tracking module may use explicit features, such as finger bone length, wrinkles, nerve layout, nails, skin type, palm lines, hair on skin, arm length, and the like. Further, the tracking module may use implicit features through statistical and deep learning techniques, such as embedded feature representation in a deep learning network.

As shown, the electronic device may also track the location of the active users in the user tracking store 165, which may be associated with the active user list 120. The user tracking store 165 may be used to track the locations of users active in a scene based on hand recognition. In some embodiments, the user tracking store may track a current location of the particular user based on a region of the view and/or environment. In some embodiments, the location information for the user may be tracked in a common coordinate system as the electronic device such that as the device moves, the location of the various users may be available.

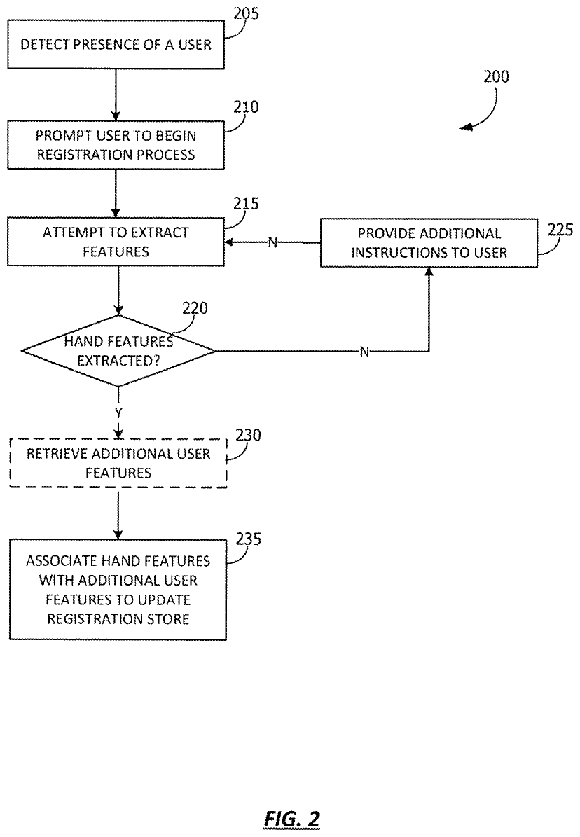

FIG. 2 depicts the flowchart of a technique for registering hands of a user, according to one or more embodiments. For purposes of explanation, the following steps will be described as being performed by particular components. However, it should be understood that the various actions may be performed by alternate components. In addition, the various actions may be performed in a different order. Further, some actions may be performed simultaneously, and some may not be required, or others may be added.

The flowchart 200 begins at block 205, where the electronic device detects the presence of the user. In one or more embodiments, the electronic device may detect that a user is initiating use of the electronic device. Additionally, or alternatively, a user may initiate a registration process to register the user's hands for identification of the user, of a gesture, or the like.

The flowchart 200 continues to block 210, where the electronic device prompts the user to begin the registration process. According to one or more embodiments, the electronic device may prompt the user to present the user's hands in a field of view of a camera. In some embodiments, the electronic device may prompt the user to perform a particular pose or gesture with the hand. Further, in some embodiments, the user may be additionally prompted to provide user-specified preferences for hand features which may be used to determine identity. For example, a user may select from finger anatomy, wrinkles, skin pattern, and the like. As such, in some embodiments, a user may select hand features to be used for identification.

At block 215, the electronic device attempts to extract the features. The features may be automatically extracted based on sensor data received by the electronic device, such as image information, depth information, and the like. The features may include explicit features, such as bone length, wrinkles, nerve layout, nails, ski type, palm lines, hair on skin, arm length, and the like, as well as implicit features such as those identified through deep learning. In some embodiments, the electronic device uses the features selected by a user. In some other embodiments, the electronic device may supplement the user-selected features with additional features, such as those identified through deep learning. In some other embodiments, the electronic device may automatically capture hand features without user input.

At block 220, a determination is made regarding whether hand features are extracted. For example, sensor data may be collected to extract sufficient features as to uniquely identify the user. If the collected sensor data is insufficient to extract the hand features, then the flowchart proceeds to block 225, where the electronic device 100 provides additional instructions to the user. In some embodiments, the additional instructions may indicate a request for a change of physical environment, such as better lighting or the like. In some cases, the additional instructions may be a request that the user repeat the pose or gesture from block 210, or to perform an additional pose or gesture. Other examples of additional instructions may include prompting the user to move at a slower pace, move their hands in a particular direction, or the like. The flowchart proceeds to block 215, where the electronic device attempts to extract hand features in accordance with the user's response to the additional instructions.

Returning to block 220, if a determination is made that the hand features have been extracted, then the flowchart continues to block 230. At block 230, the electronic device optionally retrieves additional user features associated with a profile for the user. The additional user features may be additional characteristics of the user, such as identifying features, user preferences, and the like. In some embodiments, the additional user features may include additional biometrics which may be used to identify the user. The additional user features may be retrieved, for example, from local storage, network storage or an additional device communicatively connected to electronic device across a network.

The flowchart concludes at block 235, where the electronic device 100 associates hand features extracted at block 215 with the additional user features from block 230 to update a registration store. For example, local registration may be stored within a user profile store. As such, the hand features may be stored as part of a user profile for a registered user of the electronic device. As another example, a registration store may be associated with an active user list and/or a user tracking store, in which user information is tracked for users active within the scene or environment, such as a physical environment, for a virtual environment associated with a multi-user communication session.

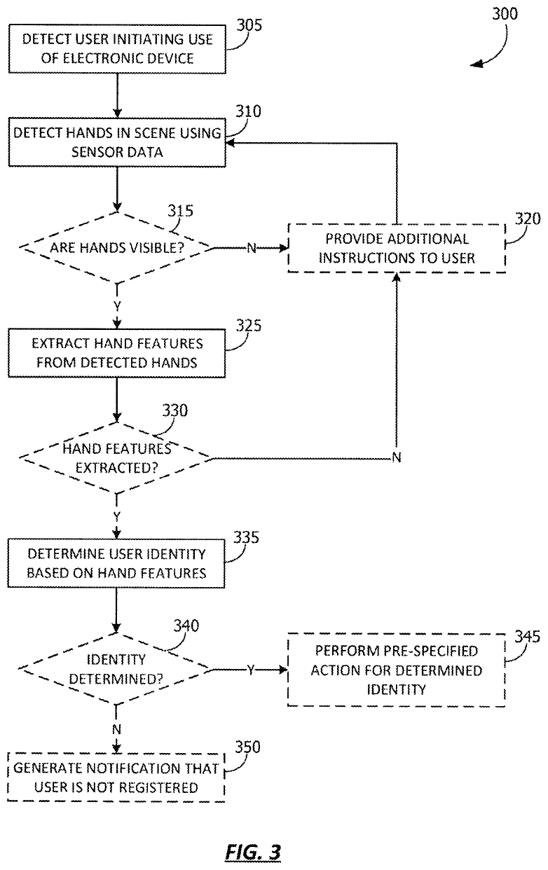

FIG. 3 depicts a flowchart 300 of a technique for identifying a user in an environment based on hand features, according to some embodiments. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart begins at block 305, where a user initiating use of an electronic device is detected. According to some embodiments, the user may be initiating use of the electronic device if the user is physically interacting with electronic device. That is, the device may detect that a user is initiating use of the device based on system processes within the device, or that the user of the device has changed. As another example, the electronic device may detect the presence of one or more hands in front of the device. In some embodiments, the electronic device may determine that detected hands are related to a new user to the device, such as one not listed in a list of current users.

At block 310, an authorization module may detect hands in a scene using sensor data. For example, sensor data from cameras and/or sensors may be used to scan a visible area of the physical environment for hands. For example, a camera stream may be used, such as image or video data. The camera may include, for example, a mono camera, stereo camera, depth sensor, and the like.

In some embodiments, the technique may include a feature for ensuring hands are sufficiently visible for extracting hand features. At block 315, optionally, a determination is made as to whether the hands are visible. In some embodiments, the hands must be present in front of the sensors for some amount of time in order to be detected, or a sufficient portion of the hand must be visible or otherwise available for collection of sensor data related to the hand. If the user hands are not visible, for example if the hand is just flashed in front of the sensor, the presence of the hand may be detected, but a determination may be made that the hands may not be sufficiently available to the sensors to collect sufficient sensor data to perform identification or tracking procedures for the hands. If the hands are not sufficiently visible, then the flowchart continues to optional block 320, where the user is provided with additional instructions. Additional instructions may prompt the user to show their hands, move their hands to a better location or better pose, and the like.

Returning to block 315, if the hands are visible, and in some embodiments, when hands are detected in the scene at block 310, then the flowchart continues to block 325. Hand features may be extracted, for example, for each hand visible in the scene, for example for which sensor data is detected at block 310. The hand features may be extracted by computer vision techniques, for example. Hand features may be extracted, as described above, by identifying one or more implicit or explicit features of the hand. For example, fingers, wrinkles, nerve layout, nails, skintight, palm lines, hair on skin, arm length, and the like. In some embodiments, the hand features may be extracted by applying the sensor data for the scene to a network trained to identify hand features from sensor data. Accordingly, intrinsic features may be identified. As will be described below, the network may be trained to identify, for example, a bounding box of the hand, keypoints on the hand (for example, points in space at which salient features are located, such as knuckle location), a hand center, a chirality of the hand, and the like.

In some embodiments, a check may be performed to ensure that hand features are sufficiently extracted. At block 330, optionally, a determination is made as to whether hand features are extracted. In some embodiments, hand features are determined to be sufficiently extracted if an identity for the hand can be determined from the features. Additionally, or alternatively, features may be sufficiently extracted if the resulting features allow for hand tracking. In some embodiments, the network may be trained to provide predicted hand features, and a determination may be made as to the confidence of the predicted features. If the features provided by the network are associated with a low confidence value, then the flow chart may proceed to block 320.

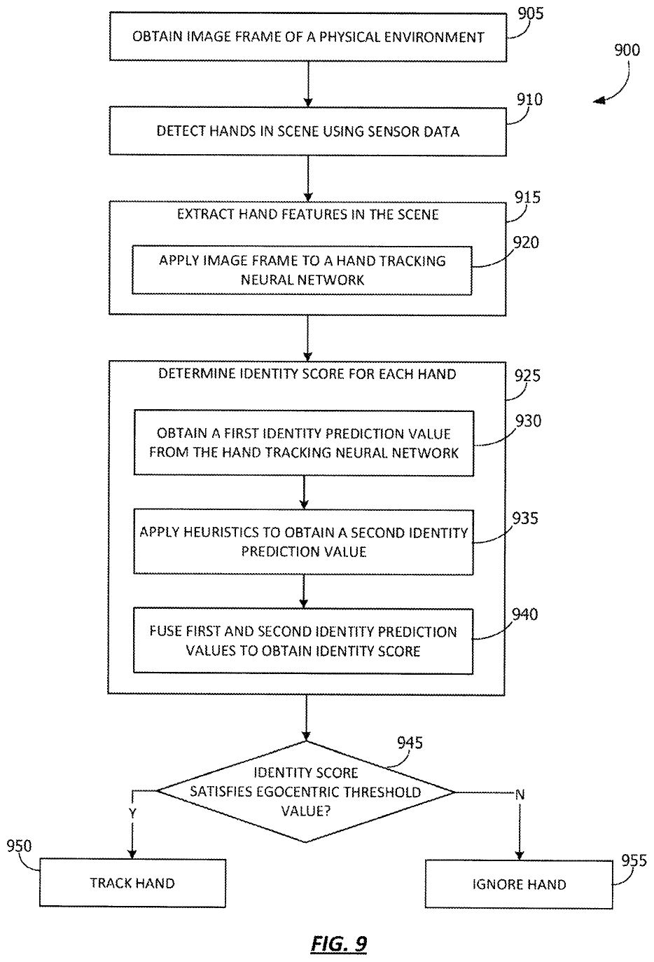

The flowchart continues to block 335, where an authentication module determines a user identity based on the hand features. In some embodiments, the authentication module may reference a user feature store, which may be stored in local storage, or in a separate device, such as network storage or an additional network device communicable coupled to electronic device. The user feature store may reference user identities based on the hand features, such as those extracted at block 325. Additionally, or alternatively, the authentication module may determine whether a particular hand belongs to a user of the device, or whether the hand belongs to another user in the environment. For example, the determined identity may be a particular identity, or may be a relational identity, such as whether the hand is associated with a user of a device or not, as will be described below with respect to FIG. 9. Accordingly, the authentication module may determine whether a hand should be tracked or should be ignored.

In some embodiments, the identity of the user may be associated with particular functionality. For example, a gesture by a user of the device may result in one action, whereas the same gesture performed by a different user in the scene may result in a different action. As such, the flowchart optionally continues to block 340, where determination is made as to whether an identity has been determined. For example, if a user identity has been found to correspond to the extracted hand features. In some embodiments, the extracted features may be compared to stored features to determine if a substantially similar match is found, such as if the extracted features are substantially similar to stored features for a particular identity. In some embodiments, the features may be compared using a trained network to determine proximity in a feature space to obtain a feature distance (e.g., a similarity value or other indicator for the similarity of two hands). The feature space may be based on embedded feature vectors obtained by deep learning, for example from training images of hands and/or historic sensor data capturing hand features. A threshold value may be used to determine whether hand features are substantially similar to registered hand features as to belong to a same identity. Additionally, the feature space may be used to identify or distinguish a user by comparing a given hand to known users, and/or to determine that two hands belong to a same user.

If an identity is determined at block 340, then the flowchart continues to block 345. At block 345, the electronic device performs a prespecified action for the determined identity. That is, the response by the electronic device to the identification may differ based on the identity of the user detected. For example, the applications or processes of the electronic device may be loaded or executed in accordance with user preference data in association with the determined identity. As another example, data associated with the user profile may be made accessible by electronic device, such as user-specific application profiles, data storage belonging to the user, and the like.

Returning to block 340, if a determination is made that an identity has not been determined, then the flowchart concludes at block 350, where the notification is generated to indicate that the user is not registered, in some embodiments. That is, the electronic device may present an indication that the hand or hands cannot be identified. In some embodiments, the user may be prompted, for example by visual or audio means, to begin a registration process, such as the registration process described above with respect to FIG. 2. In some embodiments, if the identity is not determined, then a notification may be generated to indicate the attempted unauthorized access of the electronic device. According to some embodiments, the notification may be presented locally, or may be transmitted to a secondary device for presentation. Further, in some embodiments if the identity has not been determined at 340, then a user may be prompted to use an alternative authentication method.

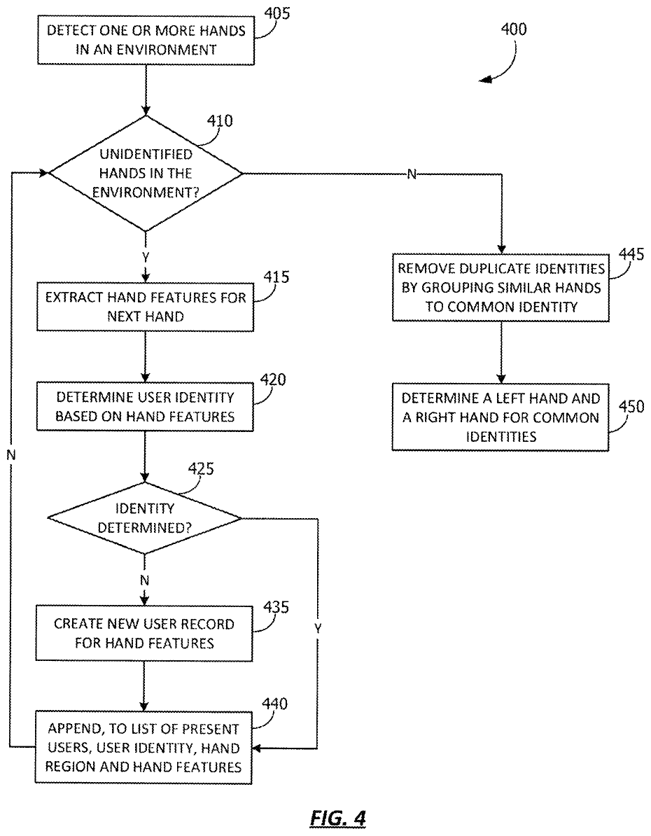

FIG. 4 shows a flowchart of a technique for managing identities of users in the environment, and accordance with some embodiments. In some embodiments, identifying individuals in the scene may be useful for authentication or authorization purposes, such as to limit the performance of sensitive actions to certain users. In addition, identifying the individuals in the scene based on hands performing gestures may prevent unwanted, unintended, or unauthorized actions. Further, by determining the identity of the users in the scene, collaboration within a multi-user communication session may be improved by moderating which actions can be performed by which actors, or only allowing vetted actors to manipulate collaborative data. In addition, differentiating individuals based on body parts, such as hands, may have additional uses. As an example, games like rock paper scissors may be enhanced by being able to determine an identity associated with a particular hand. As an example, a user's contribution to a collaborative project may be better tracked. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart begins at 405, where a system detects a hand in an environment. In some embodiments, the hand or hands may be detected based on a scan of the view of the physical environment for presence of hands by one or more sensors of an electronic device. The scan may include a target area from which sensory data is collected, either while the device is still, as a device pans across the scene, as the device moves around an environment, and the like. For example, sensor data from cameras and/or sensors may be collected during a scan an area of the physical environment for hands. A camera stream from a camera may be used to detect hands, such as a stream of picture or video data. The camera may include, for example, a mono camera, stereo camera, depth sensor, and the like. According to some embodiments, the detection of hands may be performed either continuously, or based on user input, such as a gesture or other indication.

At block 410, a determination is made as to whether there are unidentified hands detected in the environment. According to one or more embodiments, an authentication module may attempt to extract features of detected hands to determine whether the extracted features match with registered features, for example in user profile store, or a registration store. Initially, every hand in the environment may be an unidentified hand, as an authentication module performs an identification process on all hands detected in the environment. As such, the flowchart 400 continues to block 415, where hand features are extracted for another (e.g., “next”) hand. It should be understood that initially, hand features are extracted for a first hand detected in the environment, and then hand features can be extracted for a “next” hand which can be any hand other than the first hand, or a subsequent hand in a particular order (e.g., from left to right, right to left, clockwise, counterclockwise, and the like in the field of view). As described above, hand features may be extracted in a number of ways. For example, visual data, depth data, and the like may be used to analyze features of the hand, such as geometric features texture features, and the like.

At block 420, a user identity is determined based on the hand features extracted at block 415. In some embodiments, an authentication module may compare the extracted hand features to registered features, for example in a registration store, to identify a user profile associated with the features. According to some embodiments, a feature distance in feature space may be determined between the extracted features and registered features and compared to a threshold distance to determine whether an identity can be determined. The flowchart continues to block 425, where a determination is made as to whether an identity could be determined. If the identity is determined at block 425, then the flowchart continues to block 440. At block 440, the system may append the user profile or other identifying information related to the user profile to a list of active users present in the current environment. In some embodiments, the list of present users may additionally include a hand region, such as a region of the environment in which the hand is located, and the features of the hand. The features of the hand may include additional features besides the pre-registered features, and may be utilized for identification, tracking, re-identification of the user, and the like.

Returning to block 425, if a determination is made that the identity cannot be determined based on the extracted hand features, then the flowchart continues to block 435. At block 435, a new user record is created for the hand features. The new user record may be associated with an anonymous user record or a record associated with an otherwise unknown user. Then the flowchart may continue to block 440, where the new user record may be appended to the list of present users along with the anonymous for unknown user identity, the hand region for the hand, the identified features, and the like. The flowchart returns to block 410, where determination is made as to whether any further unidentified hands are detected in the environment. The processes described with respect to 415 through 440 continues until every hand in the environment is associated with a user record in the user list, either for a known user or an anonymous user.

Returning to block 410, if a determination is made that no more unidentified hands are detected in the environment, then the flowchart continues to block 445. At block 445, duplicate identities are removed by linking similar hands to common identities. According to some embodiments, duplicate identities may be determined by calculating a feature space distance between the two hands based on features detected from each of the hands. In some embodiments, a trained network of images of user hands may be used to determine a feature space, from which a feature space distance may be determined based on a similarity or dissimilarity between hand features of two hands. In some embodiments the feature space distances may be used to distinguish or cluster hands from a same person or different people. That is, if the feature space distance between two hand records is below a threshold distance, the two hand records may be determined to belong to the same person. In some embodiments, additional characteristics associated with the hands may be used to determine whether two hands belong to the same user. For example, information about arm angles, hand angles, relative position of the arms with respect to other arms, relative position of the hands with respect to other hands, and the like me be utilized in determining duplicate identities.

The flowchart concludes at block 450, where a left hand and right hand are determined for common identities where applicable. For example, for each identity that includes two hands, the two hands will be identified and registered as a left hand and a right hand based on left hand and right hand characteristics. For example, the placement of a thumb with respect to a palm of a same hand may indicate whether hand is a left hand of a right hand. In some embodiments, the list of present users may be modified to indicate the removal of duplicate identities and of the determined left-handed right hand for each user, along with the hand regions and the like. In some embodiments, managing the list of present users may allow for the system to keep track of a count of individuals in an environment.

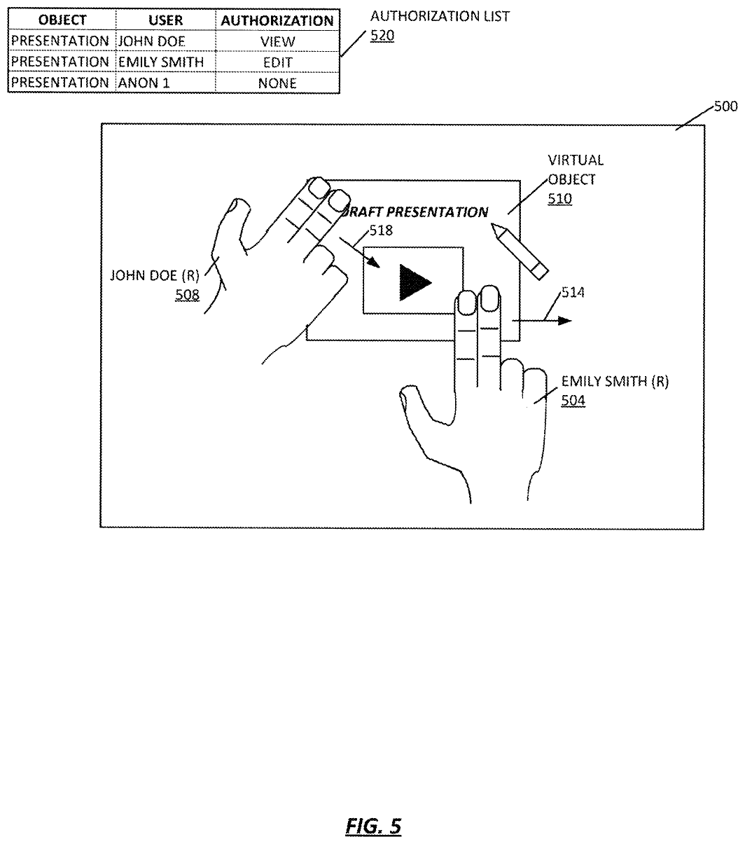

FIG. 5 shows a system set up for determining authorization of the user based on user identification, in accordance with some embodiments. For purposes of explanation, the various components and processes are explained in relation to particular components of an electronic device. However, it should be understood that the various processes and components may be performed or substituted for other processes or components as described herein. It should be understood that the system setups are depicted primarily as an example to aid in the understanding of the techniques described herein.

FIG. 5 includes a view 500 of a representation of a multiuser communication session in which several users are participating. The multiuser communication session includes virtual object 510, which is a draft presentation visible to multiple users of the multi-user communication session. As shown, the right hand of user Emily Smith 504 is performing a two finger swipe gesture 514 over the virtual object 510. Similarly, the right hand of John Doe 508 is also performing a two finger swipe gesture 518 over the virtual object 510. For purposes of the example, the two finger swipe gesture may be associated with deleting or otherwise manipulating a virtual object.

FIG. 5 also includes authorization list 520. As described above, authorization list may be stored, for example, as an authorization store. In some embodiments, authorization list 520 may be part of a user list managed by an authentication module and/or tracking module. As depicted, the authorization list 520 includes authorization information associated with objects in the multi-user communication session. As shown in the example authorization list 520, the presentation (e.g., virtual object 510) may be viewed by John Doe, but not edited. Meanwhile, user Emily Smith is authorized to edit the presentation. Further, the Anon 1 profile may have no authorization. In some embodiments, anonymous profiles may be associated with no authorization or limited authorization. As such, in some embodiments, the draft presentation may be obfuscated to the user associated with the Anon 1 profile. For instance, the draft presentation virtual objects may not be visible at all to unauthorized users, such as the user associated with the Anon 1 profile. Accordingly, as described above, the gesture 514 associated with the right hand of Emily Smith 504 may cause the virtual object 510 to be manipulated, whereas the gesture 518 associated with John Doe's right hand 508 may be detected, determined to be unauthorized for editing tasks, and ignored. In some embodiments, a log entry or notification may be generated and/or transmitted related to the unauthorized attempted action by John Doe. Accordingly, these techniques allow the electronic device to confirm the identity of hands performing a particular gesture to prevent unauthorized user within the view of an electronic device from hijacking the device, or otherwise inadvertently causing the device to perform an action based on the gesture.

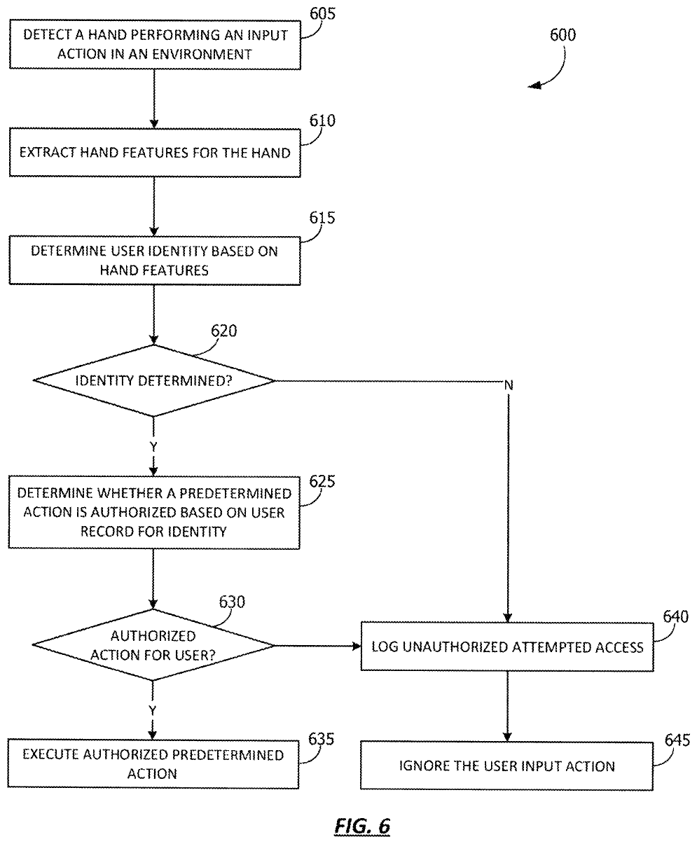

FIG. 6 shows a flowchart of a technique for determining authorization of a user based on the determined user identities, in accordance with some embodiments. In some embodiments, an electronic device may authorize certain hands to apply certain gestures to use or manipulate process of the electronic device, or to manage access to various objects in the scene. This may be useful, for example, to prevent unauthorized manipulation of sensitive data. As another example, collaboration among team members may be improved by assigning members of the team with various access levels. For example, some members of the team may only be able to view a collaborative project, whereas other members of the team may have the ability to edit or otherwise manipulate the cooperative project. In addition, members outside the team may not see the cooperative project at all, or may the simply see the obfuscated representation of the collaborative project, such as a black box or the like. As such, gestures detected from unauthorized actors can simply be ignored by the device. For purposes of explanation, the following steps will be described in the context of FIG. 1. However, it should be understood that the various actions may be performed by alternate components. In addition, the various actions may be performed in a different order. Further, some actions may be performed simultaneously, and some may not be required, or others may be added.

The flowchart begins at block 605, where a hand performing an input action is detected in the environment. The input action may be, for example, a particular pose, a particular movement, a particular gesture, and the like. In one or more embodiments, the input action may be associated with the predetermined action, such as an operation or a process by an electronic device.

The flowchart continues to block 610, where an authentication module extracts hand features for the hand. As described above, hand features may be extracted in a number of ways. For example, visual data, depth data, and the like may be utilized to analyze features of the hand, such as geometric features, texture features, and the like. At block 615, the user identity is determined based on the hand features. The user identity may be determined, for example, from a stored user list, which may include a list of users that have been detected and identified in the environment. Additionally, or alternatively, the user identity may be determined from a user profile store, which may manage identities of one or more users of the electronic device. In some embodiments, an authentication module may compare the extracted hand features to registered features, for example in a registration store, to identify a user profile associated with the features. According to some embodiments, a feature distance may be calculated based on a trained feature space based on images of various hands. The feature distance may be determined between the extracted features and registered features and compared to a threshold distance to determine whether an identity can be determined, according to some embodiments.

At block 620, a determination is made as to whether the identity could be determined. The identity may be determined, for example, by comparing the extracted hand features to registered hand features of active users in the store. If an identity can be determined, then the flowchart continues to block 625. At block 625, a determination is made whether the action is authorized based on the user record for the identity. For example, an authorization store may indicate particular authorizations for various users in the session. In some embodiments, the authorizations may be user-based or object-based. In some embodiments, the authorizations may be based on particular user profiles, characteristics of the user profiles, characteristics of the objects, and the like. For example, whether a user is a user of the local electronic device or a remote user within a shared session may indicate the level of authorization provided for various actions in the shared session.

The flowchart 600 continues to block 630, where a determination is made as to whether a predetermined action associated with the input action from 605 is an authorized action for the user. The determination may be made on the based on the authorization data obtained at block 625. If the action is authorized, then the flowchart concludes at block 635, where the electronic device executes the authorized predetermined action. In some embodiments, the predetermined action may be a process or operation performed by the local electronic device, or may be caused to be performed by a remote device. For example, a local electronic device may transmit a notification or instructions to one or more additional devices to perform the action, or the like.

Returning to block 620, if the identity is not determined, or referring to block 630, if a determination is made that the user is not authorized to cause the action to be performed, then the flowchart 600 continues to block 640. At block 640, an unauthorized attempted access is logged, according to some embodiments. For example, the authentication module may add a long entry indicating that an unknown user or an unauthorized user has attempted to perform an unauthorized action. As another example, authentication module may present a notification or transmit a notification to one or more devices indicating the unauthorized attempted action. In some embodiments, the input action associated with the predetermined action may simply be ignored, and the flowchart 600 concludes at block 645.

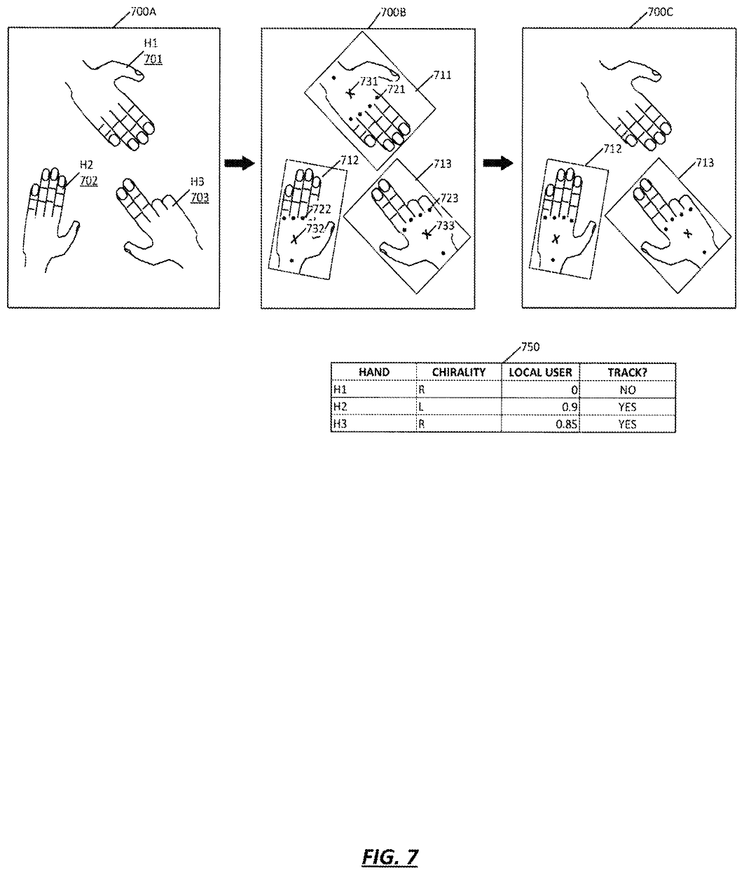

According to some embodiments, techniques are provided to determine whether a detected hand in a scene should be tracked or not. For example, in some embodiments, hands associated with a user of a system may be tracked while other hands in the scene may be ignored, such that the system performs in an “egocentric” manner. Referring to FIG. 7, a flow diagram is presented in which a device captures sensor data and processes the scene to determine whether or not the hands in the scene should be tracked. For purposes of the example, the sensor data may include image data, such as a 2D frame capturing a scene. As such, frame 700 is captured. At 700A, frame 700 is shown when the three hands in the scene are detected, including H1 701, H2 702, and H3 703.

In some embodiments, the sensor data, such as frame 700A may be applied to a trained network, such as a hand tracking neural network, to obtain predicted hand features for the hands present in the scene. As such, frame 700B shows a version of frame 700 in which features of the hand are detected. The hand features may include, for example, a bounding box, hand keypoints, a hand center, and a chirality of the hand. A set of hand features may be predicted for each hand in the scene as captured by the sensor data. As shown at 750, the chirality of the hand may be predicted for each hand. As such, hand H1 701 is associated with a bounding box 711, a set of hand features 721, and a hand center 731, and the hand is identified as a right hand. Similarly, hand H2 702 is associated with a bounding box 712, a set of hand features 722, and a hand center 732, and the hand is identified as a left hand. In addition, hand H3 703 is associated with a bounding box 713, a set of hand features 723, and a hand center 733, and the hand is identified as a right hand.

In some embodiments, the extracted features may be used to predict whether the hands belong to a particular user, such as a user local to the device collecting the sensor data, or another user in the scene. As such, a determination is made regarding whether the hand features are egocentric or not. In some embodiments, as will be described below, the determination may be made by applying a set of rules to determine whether the hand features lend themself to a local user. For example, human anatomy limits the angle at which an arm may be presented in the scene and still be associated with the local user. Said another way, the physiological limits of movement of a user may delineate rules which indicate whether a hand visible by the user belongs to the user or not. As such, a hand and/or arm within those physiological limits may indicate an egocentric hand (i.e., the hand belongs to the user), or a possibility of an egocentric hand. By contrast, a hand and/or arm outside those limits may indicate that the hand does not belong to the user. As another example, feature matching may be used to determine whether hand features belong to a user of the device. As described above, in some embodiments, a particular user's hands may have explicit or intrinsic characteristics detectable by machine vision techniques, which may be registered during an enrollment process. As such, a match between detected hand features and registered hand features may indicate that the hand may or likely belongs to the user. Additionally, or alternatively, a prediction may be made based on a trained neural network, such as the hand tracking neural network described above and below, or an additional trained neural network. In some embodiments, the predictions may be associated with an individual and/or combined local user score. The score may indicate, for example, how likely a user is to be a local user or a non-local user. For example, in some embodiments, the closer the score is to 0, the greater likelihood the user is non-local. By contrast, the closer the score is to 1, the more likely the user is local. As shown at 750, a prediction may be made, based on the features and the local user score, that H1 belongs to a non-local user, whereas H2 and H3 belong to a local user. Accordingly, as shown in 700C, bounding boxes 712 and 713 are used to track hands H2 and H3, respectively, whereas H1 is ignored.

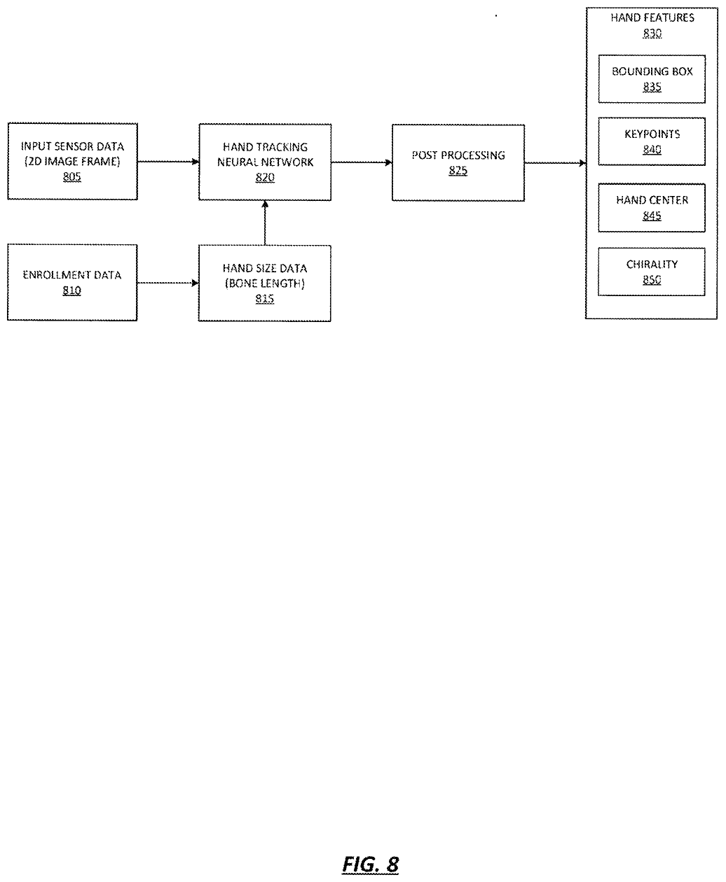

Turning to FIG. 8, a flow diagram is presented for a hand tracking technique in which a trained neural network is used to predict hand features for a particular hand in a scene. The flow diagram begins with input sensor data 805. According to one or more embodiments, the sensor data may be image data and, in particular, may be 2D RGB image data. In some embodiments, the input sensor data may or may not include 3D information such as depth information, for the scene. The sensor data may be used as input into the trained hand tracking neural network 820, which may be trained to predict hand features 830 from the sensor data, such as the 2D image frame. In some embodiments, the hand tracking neural network may also use additional data for a user, such as enrollment data 810 collected from an enrollment process. As described above, a user may utilize an enrollment process 810 to allow the system to detect identifying information for the user. Because in some embodiments, the hand tracking neural network 820 may be trained based on 2D image data, additional information may be useful to determine 3D information for the hand features. As such, hand size data 815 may be collected from the enrollment data 810. The hand size data may include explicit data regarding hand size, or may include data from which hand size may be determined, such as bone length. That is, in some embodiments, the hand tracking neural network may determine a size of a hand, and thus, 3D information in the image data, based on the bone length or other hand size data from which hand size may be determined. For example, given a size of a hand in the image data, and a known real-world size of the hand, a depth of the hand in the image may be determined.

At block 825, a post processing technique may be used to refine the predictions provided by the hand tracking neural network 820. For example, in some embodiments, the hand tracking neural networking may provide multiple predictions for a given feature, such as multiple predicted bounding boxes, and a single bounding box may be selected or determined in a post-processing step. For example, a frame may have more bounding boxes than hands present, and a post-processing step may reduce the bounding boxes to produce a single bounding box per hand.

As described above, the hand tracking neural network 820 may produce a set of hand features 830. In one or more embodiments, the hand tracking neural network may produce a set of hand features per detected hand, and/or per detected bounding box. The hand features 830 may include the bounding box 835, keypoints 840, hand center 845, and chirality 850. In one or more embodiments, the bounding box includes a set of 2D or 3D coordinates within which the hand is located. The coordinates may be represented, for example, in a coordinate system specific to the device, a global coordinate system, or the like. The keypoints 840 may include coordinates at which particular features of the hand are located. These features may be features that allow for the hand to be tracked. The keypoints may include the location at which knuckles of the hand are located, the location at which the wrist is located, and the like. The keypoints may be determined, for example, based on an identified location in the image, along with a depth, which may be determined, for example, based on a size of the hand. The hand center 845 may include coordinates for a point in space which is determined to be the center of the hand. The hand center may be determined directly from the hand tracking neural network 820, or in post-processing 825. For example, the hand center 845 may be determined to be an average point in space of the keypoints in some embodiments. Further, the center of the hand may be determined based on a weighted average of the keypoints in some embodiments. The chirality 850 may be determined based on a relative placement of the fingers, for example. In some embodiments, the chirality may be provided directly from the hand tracking neural network 820 or may be determined in post-processing. For example, if the hand tracking neural network provides keypoints indicative of different fingers on the hand, a determination of chirality (i.e., whether the hand is a left hand or a right hand) may be made based on the configuration of the keypoints in the image. In some embodiments, the chirality score may be a value between 0 and 1, where each of 0 and 1 are associated with either left or right, and the value indicates how likely a hand has a particular chirality. For example, a chirality score of 0 may be a left hand, whereas a chirality score of 1 is a right hand. A score of 0.3 may be determined to be more likely to be a left hand than a right hand, whereas a chirality score of 0.8 may be more likely to be a right hand than a left hand.

Turning to FIG. 9, a flowchart is presented showing a technique for egocentric hand tracking, according to some embodiments. That is, FIG. 9 depicts a technique for identifying hands in a scene which are associated with a particular user of a device, and ignoring other hands detected in the scene. For purposes of explanation, the following steps will be described with respect to particular components. However, it should be understood that the various actions may be performed by alternate components. In addition, the various actions may be performed in a different order. Further, some actions may be performed simultaneously, and some may not be required, or others may be added.

The flowchart 900 begins at 905 where the system obtains an image frame of a physical environment. The image frame may be obtained, for example, using a camera on an electronic device, such as an RGB camera. The image frame may be a 2D image frame or a 3D image frame. The image frame captures a scene that includes one or more hands.

The flowchart continues at block 910, where hands are detected in the scene using sensor data, such as the image data. The hands may be detected, for example, using image-based object detection or machine vision techniques. At block 915, hand features are extracted. The hand features may be extracted in a number of ways. For example, as described above, object detection may be used to identify the hands and/or characteristics of the hands. In addition, as shown at block 920, in some embodiments, the image frame may be applied to a hand tracking neural network. The hand tracking neural network, as described above with respect to FIG. 8, may be a neural network that has been trained on image data including hands, from which hand features may be determined or predicted. As described above, hand features may include, for example, a bounding box for the hand, keypoints for the hand, coordinates for a center of the hand, and a chirality of the hand.

At block 925, an identity score is determined for each hand in the scene. The identity score may determine, for example, a prediction as to whether the hand belongs to a local user or a non-local user. The identity score may be represented in a number of ways, such as a numerical value between 0 and 1, indicating the likelihood that the hand belongs to a local user. The identity score may be determined by a single process, or a combination of multiple processes. As shown at block 930, in some embodiments, a first identity prediction value is obtained from a trained networking. In some embodiments, the hand tracking neural network described above with respect to FIG. 8 may be additionally be trained to predict whether a particular hand belongs to a local user and, as such, may provide the prediction value. Additionally, or alternatively, a separate network may be used, such as a network trained on hand features, such as those described above, to predict whether a particular set of hand features indicates a hand belongs to a user. The flowchart 900 continues at block 935 where, in some embodiments, heuristics are applied to obtain a second identity prediction value. The heuristics may be a set of rules which, when applied to the hand features, determines whether a particular hand belongs to a local user, and/or how likely a particular hand belongs to a local user. For example, an arm in the image at a particular angle may be physiologically impossible to perform by a user of a device viewing the scene. The flowchart 900 continues at bock 940 where, optionally, the identity score is obtained by fusing the first identity value from block 930, and the second identity value from block 935. The identity values may be combined in a number of ways. For example, the identity values may be averaged, or weighted to obtain the identity score.

A determination is made at bock 945 as to whether the identity score satisfies an egocentric threshold value. That is, the determination is made as to whether the identity score satisfies a threshold value at which it can be determined that the hand associated with the score belongs to a local user. If a determination is made at block 945 that the identity score satisfies the egocentric threshold value, then the flowchart 900 continues at block 950 and the hand is tracked. In some embodiments, the hand features extracted at block 915 may be used to track the hand across additional frames, and may be tracked to determine whether a particular movement or gesture is performed which is associated with predetermined instructions. However, if at block 945 a determination is made that the identity score does not satisfy the egocentric threshold value, then the flowchart continues at block 955 and the hand is ignored.

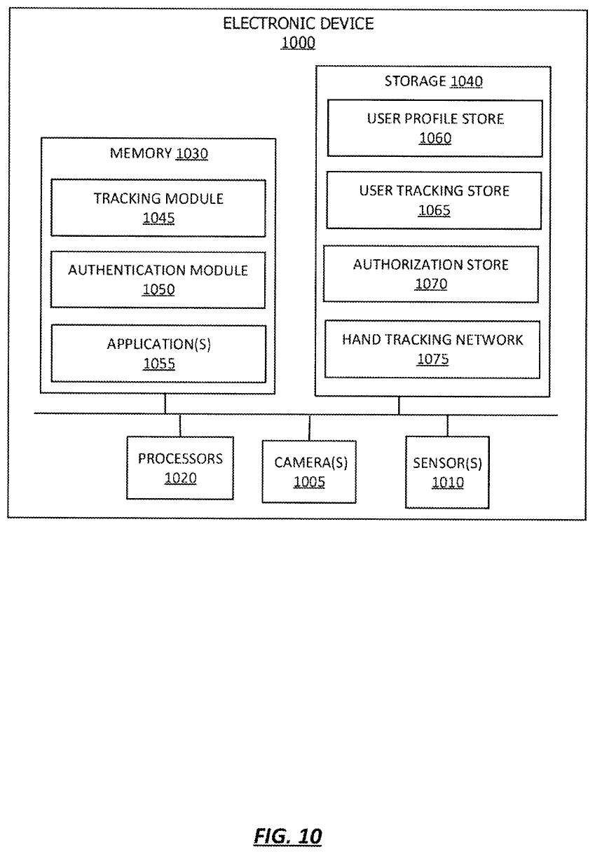

Referring to FIG. 10, a simplified block diagram of an electronic device 1000 is depicted. Electronic device 1000 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 1000 may include one or more additional devices within which the various functionality may be contained, or across which the various functionality may be distributed, such as server devices, base stations, accessory devices, and the like. Illustrative networks include, but are not limited to, a local network such as a universal serial bus (USB) network, an organization's local area network, and a wide area network such as the Internet. According to one or more embodiments, electronic device 1000 is utilized to participate in an XR multi-user communication session. It should be understood that the various components and functionality within electronic device 1000 may be differently distributed across the modules or components, or even across additional devices.

Electronic Device 1000 may include one or more processors 1020, such as a central processing unit (CPU) or graphics processing unit (GPU). Electronic device 1000 may also include a memory 1030. Memory 1030 may include one or more different types of memory, which may be used for performing device functions in conjunction with processor(s) 1020. For example, memory 1030 may include cache, ROM, RAM, or any kind of transitory or non-transitory computer readable storage medium capable of storing computer readable code. Memory 1030 may store various programming modules for execution by processor(s) 1020, including tracking module 1045, authentication module 1050, and other various applications 1055. Electronic device 1000 may also include storage 1040. Storage 1040 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). or other multi-camera system, a time-of-flight camera system, or the like. Storage 1030 may be utilized to store various data and structures which may be utilized for storing data related to hand features and user identification and tracking. Storage 1040 may be configured to store user profile store 1060, user tracking store 1065, authorization store 1070, and hand tracking network 1075 according to one or more embodiments. Electronic device may additionally include a network interface from which the electronic device 1000 can communicate across a network.

Electronic device 1000 may also include one or more cameras 1005 or other sensors 1010, such as a depth sensor, from which depth of a scene may be determined. In one or more embodiments, each of the one or more cameras 1005 may be a traditional RGB camera, or a depth camera. Further, cameras 1005 may include a stereo.

According to one or more embodiments, memory 1030 may include one or more modules that comprise computer readable code executable by the processor(s) 1020 to perform functions. The memory may include, for example, tracking module 1045, authentication module 1050, and one or more additional application(s) 1055. The tracking module 1045 may be used to track locations of hands in a physical environment. The tracking module may use sensor data, such as data from cameras 1005 and/or sensors 1010. In some embodiments, the authentication module 1050 may identify an individual based on features of hands or other characteristics of the user. For example, the tracking module may use explicit features, such as finger bone length, wrinkles, nerve layout, nails, skin type, palm lines, hair on skin, arm length, and the like. In one or more embodiments, the authentication module may detect input actions performed by hands in the scene, and determine that the user performing the input action is authorized to perform the predetermined action associated with the gesture, for example based on authorization store 1070. If the action is not authorized, then the input action may be ignored.

Although electronic device 1000 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, some combination of the functionality of any of the components may be combined.

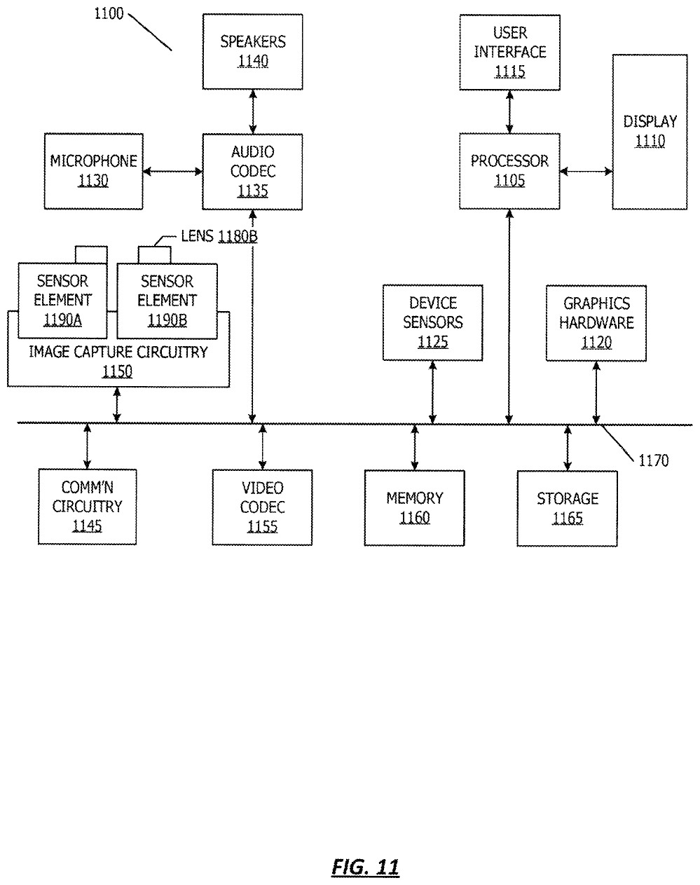

Referring now to FIG. 11, a simplified functional block diagram of illustrative multifunction electronic device 1100 is shown according to one embodiment. Each of electronic devices may be a multifunctional electronic device, or may have some or all of the described components of a multifunctional electronic device described herein. Multifunction electronic device 1100 may include processor 1105, display 1110, user interface 1115, graphics hardware 1120, device sensors 1125 (e.g., proximity sensor/ambient light sensor, accelerometer and/or gyroscope), microphone 1130, audio codec(s) 1135, speaker(s) 1140, communications circuitry 1145, digital image capture circuitry 1150 (e.g., including camera system) video codec(s) 1155 (e.g., in support of digital image capture unit), memory 1160, storage device 1165, and communications bus 1170. Multifunction electronic device 1100 may be, for example, a digital camera or a personal electronic device such as a personal digital assistant (PDA), personal music player, mobile telephone, or a tablet computer.

Processor 1105 may execute instructions necessary to carry out or control the operation of many functions performed by device 1100 (e.g., such as the generation and/or processing of images as disclosed herein). Processor 1105 may, for instance, drive display 1110 and receive user input from user interface 1115. User interface 1115 may allow a user to interact with device 1100. For example, user interface 1115 can take a variety of forms, such as a button, keypad, dial, a click wheel, keyboard, display screen and/or a touch screen. Processor 1105 may also, for example, be a system-on-chip such as those found in mobile devices and include a dedicated graphics processing unit (GPU). Processor 1105 may be based on reduced instruction-set computer (RISC) or complex instruction-set computer (CISC) architectures or any other suitable architecture and may include one or more processing cores. Graphics hardware 1120 may be special purpose computational hardware for processing graphics and/or assisting processor 1105 to process graphics information. In one embodiment, graphics hardware 1120 may include a programmable GPU.

Image capture circuitry 1150 may include two (or more) lens assemblies 1180A and 1180B, where each lens assembly may have a separate focal length. For example, lens assembly 1180A may have a short focal length relative to the focal length of lens assembly 1180B. Each lens assembly may have a separate associated sensor element 1190. Alternatively, two or more lens assemblies may share a common sensor element. Image capture circuitry 1150 may capture still and/or video images. Output from image capture circuitry 1150 may be processed, at least in part, by video codec(s) 1155 and/or processor 1105 and/or graphics hardware 1120, and/or a dedicated image processing unit or pipeline incorporated within circuitry 1165. Images so captured may be stored in memory 1160 and/or storage 1165.

Sensor and camera circuitry 1150 may capture still and video images that may be processed in accordance with this disclosure, at least in part, by video codec(s) 1155 and/or processor 1105 and/or graphics hardware 1120, and/or a dedicated image processing unit incorporated within circuitry 1150. Images so captured may be stored in memory 1160 and/or storage 1165. Memory 1160 may include one or more different types of media used by processor 1105 and graphics hardware 1120 to perform device functions. For example, memory 1160 may include memory cache, read-only memory (ROM), and/or random access memory (RAM). Storage 1165 may store media (e.g., audio, image and video files), computer program instructions or software, preference information, device profile information, and any other suitable data. Storage 1165 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 1160 and storage 1165 may be used to tangibly retain computer program instructions or code organized into one or more modules and written in any desired computer programming language. When executed by, for example, processor 1105 such computer program code may implement one or more of the methods described herein.

A first example of the disclosure includes a non-transitory computer readable medium comprising computer readable code executable by one or more processors to receive, at a first device, sensor data of a scene comprising one or more hands; obtain, for a first hand of the one or more hands, a first set of hand features based on the sensor data; and determine, based on the first set of hand features, a first user identity associated with the first hand.

In a second example of the disclosure, the first example further includes computer readable code to: determine, based on the first user identity, a first user profile; and provide access to a functionality of the device in accordance with the first user profile.

In a third example, the computer readable code to provide access to the functionality of the device for the second example further comprises computer readable code to: detect a user input action performed by the first hand; determine, based on authorization data, that the first user profile is authorized for a predetermined action associated with the user input action; and in accordance with a determination that the user profile is authorized for the predetermined action, cause the predetermined action to be performed.

In a fourth example, the computer readable code to provide access to the functionality of the device for the second example further comprises computer readable code to: detect a user input action performed by the first hand; determine, based on authorization data, that the first user profile is authorized to perform a predetermined action associated with the user input action; and in accordance with a determination that the user profile is not authorized to perform the predetermined action, ignore the user input action.

In a fifth example, the fourth example further includes computer readable code to, in accordance with the determination that the user profile is not authorized to perform the predetermined action, generate an attempted unauthorized access notification.

In a sixth example, any of the second through fifth examples further includes computer readable code to: append the first user identity to a list of active users in the scene.

In a seventh example, the sixth example further includes computer readable code to: extract, for each additional hand of the one or more hands, additional hand features; determine one or more additional user identities based on the additional hand features; and generate additional user records for the one or more additional user identities in the list of active users in the scene.

In an eighth example, the seventh example further includes computer readable code to: determine one or more sets of duplicated identities based on the extracted hand features and the additional hand features; and remove duplicated identities from the list of active users in the scene.

In a ninth example, the computer readable code to determine one or more sets of duplicated identities of the eighth example further comprises computer readable code to: obtain implicit features for two of the one or more hands; and compute feature space distance between two or more of the one or more hands based on a pre-trained feature network.

In a tenth example, the duplicated identities of the eighth example are further determined based on one or more from a group consisting of an arm angle, a hand angle, a relative position of arms of the user, and a relative position of hands of the user.

In an eleventh example, the eighth example further includes computer readable code to: identify, for a particular user identity, a left hand and a right hand from the one or more hands; and indicate the left hand and the right hand for the particular user identity in the list of active users in the scene.

In a twelfth example, the computer readable code to determine the first user identity of the first example further comprises computer readable code to: compare the first set of hand features with a set of registered hand features stored in a user feature store.

In a thirteenth example, the twelfth example further includes computer readable code to: detect a second hand in the scene; extract, for the second hand, a second set of hand features; compare the second set of hand features with the set of registered hand features stored in the user feature store; determine, based on comparison of the second set of hand features with the set of registered hand features, that the second hand does not belong to a known user; and generate a first anonymous user record for the second hand based on the second set of hand features.

In a fourteenth example, the thirteenth example further includes computer readable code to: append the anonymous user record to a list of active users in the scene.

In a fifteenth example, the user feature store of any of the twelfth to fourteenth examples comprises one or more user records from user registration associated with additional user features.

In a sixteenth example, the computer readable code to obtain a first set of hand features of the first example further comprises computer readable code to: apply the sensor data to a network trained to predict hand features based on provided sensor data.

In a seventeenth example, the network of the sixteenth example is further trained to predict hand features based on provided enrollment data.

In an eighteenth example, the provided enrollment data of the seventeenth example comprises a bone length.

In a nineteenth example, the sensor data of the sixteenth example comprises a 2D image frame.

In a twentieth example, the first set of hand features of any of the first through nineteenth examples comprises at least one selected from a group consisting of a bounding box, a set of keypoints, a hand center, and a chirality.

In a twenty-first example, the first set of hand features of the twentieth example further comprises a confidence value for the first user identity.

In a twenty-second example, the computer readable code to determine the first user identity of the twenty-first example further comprises computer readable code to: apply a set of identity heuristics to the first set of hand features.

In a twenty third example, the non-transitory computer readable medium of any of the sixteenth to twenty-second examples, further comprising computer readable code to: determine that the first user identity is associated with a user of the first device; and in accordance with the determination, track the first hand.

In a twenty-fourth example, the non-transitory computer readable medium of any of the sixteenth to twenty-second examples, further comprising computer readable code to: determine that the first user identity is associated with a person in the environment different than a user of the first device; and in accordance with the determination, ignore the first hand.

A twenty-fifth example includes a system comprising: one or more processors; and one or more computer readable media comprising computer readable code executable by the one or more processors to: receive, at a first device, sensor data of a scene comprising one or more hands; obtain, for a first hand of the one or more hands, a first set of hand features based on the sensor data; and determine, based on the first set of hand features, a first user identity associated with the first hand.

In a twenty-sixth example, the system of the twenty-fifth example further includes computer readable code to: append the first user identity to a list of active users in the scene.

In a twenty-seventh example, the system of the twenty-fifth example further includes computer readable code to: extract, for each additional hand of the one or more hands, additional hand features; determine one or more additional user identities based on the additional hand features; and generate additional user records for the one or more additional user identities in the list of active users in the scene.

In a twenty-eighth example, the system of the twenty-seventh example further includes computer readable code to: determine one or more sets of duplicated identities based on the extracted hand features and the additional hand features; and remove duplicated identities from the list of active users in the scene.

In a twenty-ninth example, the computer readable code of the twenty-seventh example to determine one or more sets of duplicated identities further comprises computer readable code to: obtain implicit features for two of the one or more hands; and compute feature space distance between two or more of the one or more hands based on a pre-trained feature network.

In a thirtieth example, the duplicated identities of the twenty-ninth example are further determined based on one or more from a group consisting of an arm angle, a hand angle, a relative position of arms of the user, and a relative position of hands of the user.

In a thirty-first example, thirtieth example further includes computer readable code to: identify, for a particular user identity, a left hand and a right hand from the one or more hands; and indicate the left hand and the right hand for the particular user identity in the list of active users in the scene.

In a thirty-second example, the computer readable code to determine the first user identity of the twenty-fifth example further comprises computer readable code to: compare the first set of hand features with a set of registered hand features stored in a user feature store.

In a thirty-third example, the system of the thirty-second example further includes computer readable code to detect a second hand in the scene; extract, for the second hand, a second set of hand features; compare the second set of hand features with the set of registered hand features stored in the user feature store; determine, based on comparison of the second set of hand features with the set of registered hand features, that the second hand does not belong to a known user; and generate a first anonymous user record for the second hand based on the second set of hand features.

In a thirty-fourth example, the thirty-third example further includes append the anonymous user record to a list of active users in the scene.

In a thirty-fifth example, the user feature store of any of the thirty-second to thirty-fourth example comprises one or more user records from user registration associated with additional user features.

In a thirty-sixth example, the computer readable code to obtain a first set of hand features of the twenty-fifth example further comprises computer readable code to: apply the sensor data to a network trained to predict hand features based on provided sensor data.

In a thirty-seventh example, the network of the thirty-sixth example is further trained to predict hand features based on provided enrollment data.

In a thirty-eighth example, the provided of the enrollment data thirty-seventh example comprises a bone length.

In a thirty-ninth example, the sensor data of the twenty-fifth example comprises a 2D image frame.

In a fortieth example, the first set of hand features of any of the twenty-fifth to thirty-ninth example comprises at least one selected from a group consisting of a bounding box, a set of keypoints, a hand center, and a chirality.

In a forty-first example, the first set of hand features of the fortieth example further comprises a confidence value for the first user identity.

In a forty-second example, the computer readable code to determine the first user identity of the forty-first example further comprises computer readable code to: apply a set of identity heuristics to the first set of hand features.

In a forty-third example, any of the thirty-sixth to forty-second examples further include computer readable code to: determine that the first user identity is associated with a user of the first device; and in accordance with the determination, track the first hand.

In a forty-third example, any of the thirty-sixth to forty-second examples further include computer readable code to: determine that the first user identity is associated with a person in the environment different than a user of the first device; and in accordance with the determination, ignore the first hand.

Various processes defined herein consider the option of obtaining and utilizing a user's identifying information. For example, such personal information may be utilized in order to identify users based on hand features. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established and in compliance with, or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-4, 6, and 8-9 or the arrangement of elements shown in FIGS. 1, 5, 7 and 10-11 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method, comprising:
receiving, at a first device, sensor data of a scene comprising one or more hands;
obtaining, for a first hand of the one or more hands, a first set of hand features based on the sensor data; and
determining, based on the first set of hand features, a first user identity associated with the first hand.

2. The method of claim 1, further comprising:
determining, based on the first user identity, a first user profile; and
providing access to a functionality of the device in accordance with the first user profile.

3. The method of claim 2, wherein providing access to the functionality of the device further comprises:
detecting a user input action performed by the first hand;
determining, based on authorization data, that the first user profile is authorized for a predetermined action associated with the user input action; and
in accordance with a determination that the user profile is authorized for the predetermined action, causing the predetermined action to be performed.

4. The method of claim 2, wherein providing access to the functionality of the device further comprises:
detecting a user input action performed by the first hand;
determining, based on authorization data, that the first user profile is authorized to perform a predetermined action associated with the user input action; and
in accordance with a determination that the user profile is not authorized to perform the predetermined action, ignoring the user input action.

5. The method of claim 4, further comprising, in accordance with the determination that the user profile is not authorized to perform the predetermined action, generating an attempted unauthorized access notification.

6. The method of claim 1, further comprising:
appending the first user identity to a list of active users in the scene;
extracting, for each additional hand of the one or more hands, additional hand features;
determining one or more additional user identities based on the additional hand features; and
generating additional user records for the one or more additional user identities in the list of active users in the scene.

7. The method of claim 6, further comprising:
determining one or more sets of duplicated identities based on the extracted hand features and the additional hand features by:
obtaining implicit features for two of the one or more hands, and
computing feature space distance between two or more of the one or more hands based on a pre-trained feature network; and
removing duplicated identities from the list of active users in the scene.

8. The method of claim 7, wherein the duplicated identities are further determined based on one or more from a group consisting of an arm angle, a hand angle, a relative position of arms of the user, and a relative position of hands of the user.

9. The method of claim 7, further comprising:
identifying, for a particular user identity, a left hand and a right hand from the one or more hands; and
indicating the left hand and the right hand for the particular user identity in the list of active users in the scene.

10. The method of claim 1, wherein determining the first user identity further comprises:
comparing the first set of hand features with a set of registered hand features stored in a user feature store;
detecting a second hand in the scene;
extracting, for the second hand, a second set of hand features;
comparing the second set of hand features with the set of registered hand features stored in the user feature store;
determining, based on comparison of the second set of hand features with the set of registered hand features, that the second hand does not belong to a known user; and
generating a first anonymous user record for the second hand based on the second set of hand features.

11. The method of claim 10, further comprising:
appending the anonymous user record to a list of active users in the scene.

12. A non-transitory computer readable medium comprising computer readable code executable by one or more processors to:
receive, at a first device, sensor data of a scene comprising one or more hands;
obtain, for a first hand of the one or more hands, a first set of hand features based on the sensor data; and
determine, based on the first set of hand features, a first user identity associated with the first hand.

13. The non-transitory computer readable medium of claim 12, wherein obtaining a first set of hand features further comprises:
applying the sensor data to a network trained to predict hand features based on provided sensor data, wherein the network is further trained to predict hand features based on provided enrollment data.

14. The non-transitory computer readable medium of claim 13, wherein the provided enrollment data comprises a bone length.

15. The non-transitory computer readable medium of claim 12, wherein the first set of hand features comprises at least one selected from a group consisting of a bounding box, a set of keypoints, a hand center, and a chirality.

16. The non-transitory computer readable medium of claim 15, wherein the first set of hand features further comprises a confidence value for the first user identity.

17. The non-transitory computer readable medium of claim 16, wherein the computer readable code to determine the first user identity further comprises computer readable code to:
apply a set of identity heuristics to the first set of hand features.

18. The non-transitory computer readable medium of claim 12, further comprising computer readable code to:
determine that the first user identity is associated with a user of the first device; and
in accordance with the determination, track the first hand.

19. The non-transitory computer readable medium of claim 12, further comprising computer readable code to:
determine that the first user identity is associated with a person in the environment different than a user of the first device; and
in accordance with the determination, ignore the first hand.

20. A system comprising:
one or more processors; and
one or more computer readable media comprising computer readable code executable by the one or more processors to:
receive, at a first device, sensor data of a scene comprising one or more hands;
obtain, for a first hand of the one or more hands, a first set of hand features based on the sensor data; and
determine, based on the first set of hand features, a first user identity associated with the first hand.
